(19) United States
(12) Patent Application Publication
(10) Pub. No.: US 2023/0050172 A1
(43) Pub. Date: Feb. 16, 2023

(54) MOVABLE BODY CONTROL SYSTEM, CONTROL APPARATUS, CONTROL METHOD AND RECORDING MEDIUM

(71) Applicant: NEC Corporation, Minato-ku, Tokyo (JP)

(72) Inventor: Yuichi YANO, Tokyo (JP)

(73) Assignee: NEC Corporation, Minato-ku, Tokyo (JP)

(21) Appl. No.: 17/793,736

(22) PCT Filed: Feb. 4, 2021
(86) PCT No.: PCT/JP2021/004063

§ 371 Date: Jul. 19, 2022

(30) Foreign Application Priority Data
Mar. 11, 2020 (JP) 2020-041803

(51) Int. Cl. G05D 1/02; H04W 4/40; H04W 64/00

(52) U.S. Cl. CPC G05D 1/0212; G05D 1/0287; H04W 4/40; H04W 64/006

(57) ABSTRACT

A movable body control system (SYS) includes first and second movable bodies (1#1, 1#2) that are movable in a predetermined area (TA) in which a wireless communication network (NW) is built; and a control apparatus (3) for controlling the first and second movable bodies through the wireless communication network, the control apparatus includes: a storage unit (32) for storing a first communication quality information that indicates a communication quality in the predetermined area when the first movable body exists in each of a plurality of different locations in the predetermined area; a generation unit (311) for generating, based on the first communication quality information, a target moving route (TGT#2) that allows the second movable body to move while avoiding a first low quality location (DA_low1) at which the communication quality does not reach a desired quality due to the first movable body; and a control unit (312) for controlling the second movable body so that the second movable body moves along the target moving route.

### TECHNICAL FIELD

This disclosure relates to a technical field of a movable body control system, a control apparatus, a control method and a recording medium that are configured to control a movable body.

### BACKGROUND ART

A control apparatus that is configured to control a movable body that is configured to autonomously move in a facility such as a plant is known. For example, a Patent Literature 1 discloses a control apparatus that is configured to change a guide command for a movable body by using condition data indicating a communication condition that is obtained by communicating a wireless access point.

Additionally, there is a Patent Literature 2 to a Patent Literature 5 as a background art document related to this disclosure.

### CITATION LIST

### Patent Literature

Patent Literature 1: JP2019-148870A
Patent Literature 2: JP2003-005833A
Patent Literature 3: JP2012-137909A
Patent Literature 4: JP2016-139893A
Patent Literature 5: JP2010-018410A

### SUMMARY

### Technical Problem

When a plurality of movable bodies move in the facility, there is a possibility that the plurality of movable bodies interfere in a communication with each other. Specifically, an area in which a communication quality does not reach a desired quality due to an existence of each movable body is generated around each movable body. Therefore, when another movable body moves in an area in which the communication quality does not reach the desire level due to one movable body, there is a possibility that a communication between another movable body and the control apparatus is not stable. The apparatuses disclosed in the Patent Literatures 1 to 5 described above do not consider that the area in which the communication quality does not reach the desired quality due to each movable body is generated. Therefore, the apparatuses disclosed in the Patent Literatures 1 to 5 described above have such a technical problem that they are not capable of properly control the plurality of movable bodies.

It is an example object of this disclosure to provide a movable body control system, a control apparatus, a control method and a recording medium that are configured to solve the above described technical problem. As one example, it is an example object of this disclosure to provide a movable body control system, a control apparatus, a control method and a recording medium that are configured to properly control a plurality of movable bodies.

### Solution to Problem

One example aspect of a movable body control system includes a first movable body that is movable in a predetermined area in which a wireless communication network is built; a second movable body that is movable in the predetermined are; and a control apparatus that is configured to control each of the first and second movable bodies through the wireless communication network, the control apparatus includes: a storage unit that is configured to store a first communication quality information that indicates a communication quality in the predetermined area when the first movable body exists in each of a plurality of different locations in the predetermined area; a generation unit that is configured to generate, based on the first communication quality information, a target moving route that allows the second movable body to move while avoiding a first low quality location at which the communication quality does not reach a desired quality due to the first movable body; and a control unit that is configured to control the second movable body so that the second movable body moves along the target moving route.

One example aspect of a control apparatus is a control apparatus that is configured to control, through a wireless communication network, a first movable body and a second movable body that are movable in a predetermined area in which the wireless communication network is built, the control apparatus includes: a storage unit that is configured to store a first communication quality information that indicates a communication quality in the predetermined area when the first movable body exists in each of a plurality of different locations in the predetermined area; a generation unit that is configured to generate, based on the first communication quality information, a target moving route that allows the second movable body to move while avoiding a first low quality location at which the communication quality does not reach a desired quality due to the first movable body; and a control unit that is configured to control the second movable body so that the second movable body moves along the target moving route.

One example aspect of a control method is a control method of controlling, through a wireless communication network, a first movable body and a second movable body that are movable in a predetermined area in which the wireless communication network is built, the control method includes: obtaining a fist communication quality information from a storage unit that is configured to store the first communication quality information that indicates a communication quality in the predetermined area when the first movable body exists in each of a plurality of different locations in the predetermined area; generating, based on the first communication quality information, a target moving route that allows the second movable body to move while avoiding a first low quality location at which the communication quality does not reach a desired quality due to the first movable body; and controlling the second movable body so that the second movable body moves along the target moving route.

One example aspect of a recording medium is a recording medium on which a computer program that allows a computer to execute a control method is recorded, wherein the control method is a control method of controlling, through a wireless communication network, a first movable body and a second movable body that are movable in a predetermined area in which the wireless communication network is built, and includes: obtaining a fist communication quality information from a storage unit that is configured to store the first communication quality information that indicates a communication quality in the predetermined area when the first movable body exists in each of a plurality of different locations in the predetermined area; generating, based on the first communication quality information, a target moving route that allows the second movable body to move while avoiding a first low quality location at which the communication quality does not reach a desired quality due to the first movable body; and controlling the second movable body so that the second movable body moves along the target moving route.

### Effect

The movable body control system, the control apparatus, the control method and the recording medium described above are capable of properly control the plurality of movable bodies.

### BRIEF DESCRIPTION OF DRAWINGS

FIG. 1 is a block diagram that illustrates an entire configuration of a movable body control system in a present example embodiment.

FIG. 2 is a planar view that conceptually illustrates a transport area to which the movable body control system in the present example embodiment is applied.

FIG. 3 is a block diagram that illustrates a configuration of a movable body in the present example embodiment.

FIG. 4 is a block diagram that illustrates a configuration of a control server in the present example embodiment.

FIG. 5 is a flow chart that illustrates a flow of a movable body control operation.

FIG. 6 is a planar view that illustrates one example of a grid map.

FIG. 7 is a planar view that illustrates one example of a target moving route for the movable body on the grid map.

Each of FIG. 8A and FIG. 8B is a planar view that illustrates one example of an signal strength map.

FIG. 9 is a planar view that illustrates a moving movable body and a low strength area that moves along with the moving movable body on the grid map.

FIG. 10 is a planar view that illustrates the moving movable body and the low strength area that moves along with the moving movable body on the grid map.

FIG. 11 is a planar view that illustrates the moving movable body and the low strength area that moves along with the moving movable body on the grid map.

FIG. 12 is a planar view that illustrates the moving movable body and the low strength area that moves along with the moving movable body on the grid map.

FIG. 13 is a planar view that illustrates the moving movable body and the low strength area that moves along with the moving movable body on the grid map.

FIG. 14 is a planar view that illustrates the moving movable body and the low strength area that moves along with the moving movable body on the grid map.

### DESCRIPTION OF EXAMPLE EMBODIMENTS

Next, an example embodiment of a movable body control system, a control apparatus, a control method and a recording medium will be described with reference to the drawings. In the below described description, the example embodiment of the movable body control system, the control apparatus, the control method and the recording medium will be described by using a movable body control system SYS that is configured to control movements of a plurality of movable bodies 1 that are movable in a transport area TA in a warehouse.

However, the movable body control system SYS may be configured to control any movable body 1 that is movable in any area. For example, the movable body control system SYS may be configured to control any movable body 1 that is movable in any area in at least one of a factory, a hospital, a station, an airport and a shopping mall.

### 1 Configuration of Movable Body Control System SYS

### 1-1 Entire Configuration of Movable Body Control System SYS

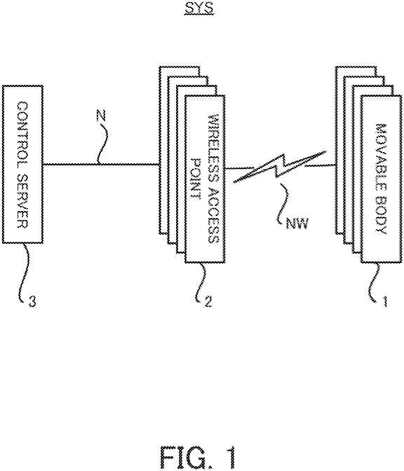

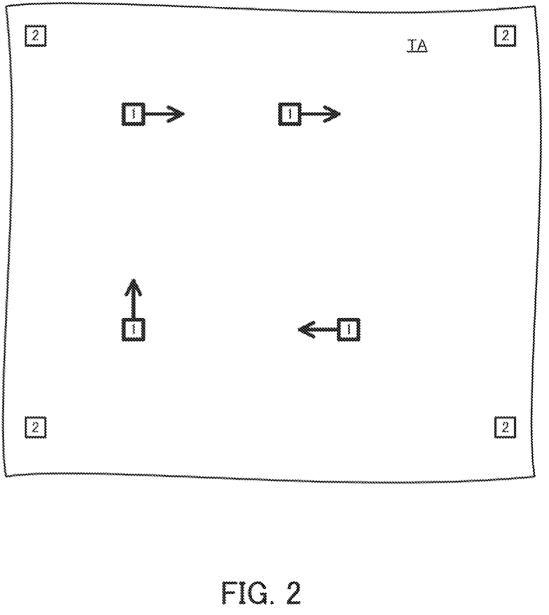

Firstly, with reference to FIG. 1 and FIG. 2, an entire configuration of the movable body control system SYS in the present example embodiment will be described. FIG. 1 is a block diagram that illustrates an entire configuration of the movable body control system SYS in the present example embodiment. FIG. 2 is a planar view that conceptually illustrates the transport area TA to which the movable body control system SYS in the present example embodiment is applied.

As illustrated in FIG. 1, the movable body control system SYS includes a plurality of movable bodies 1, a plurality of wireless access points 2, and a control server 3. However, the movable body control system SYS may include a single wireless access point 2.

As illustrated in FIG. 2, the plurality of movable bodies 1 and the plurality of wireless access points 2 are located in the transport area TA. On the other hand, the control server 3 may not be located in the transport area TA. For example, the control server 3 may be located in a management room or a server room prepared in the warehouse or outside the warehouse.

Each movable body 1 is autonomously movable in the transport area TA under the control of the control server 3. Specifically, each movable body 1 is autonomously movable along a target moving route TGT generated by the control server 3 in the transport area TA. An Automated Guided Vehicle is one example of the movable body 1. In this case, the movable body 1 may move in the transport area TA to transport an item.

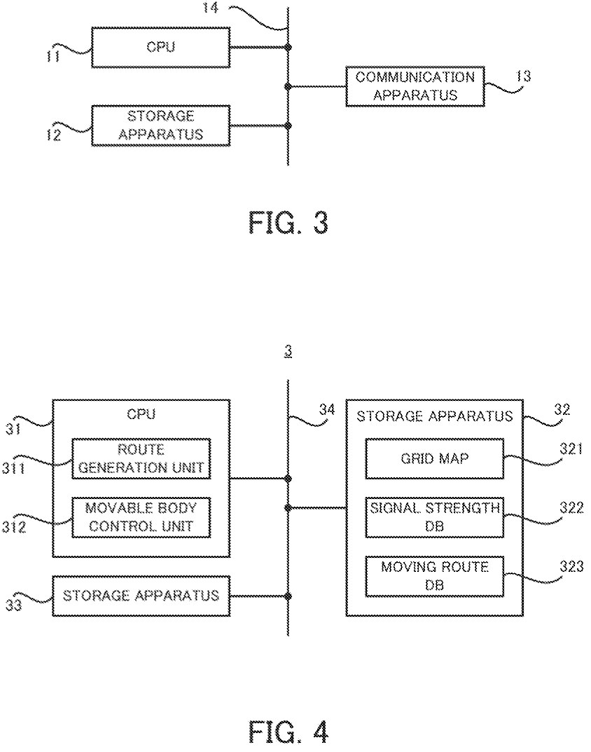

Each movable body 1 includes a CPU (Central Processing Unit) 11, a storage apparatus 12 and a communication apparatus 13, as illustrated in FIG. 3 that is a block diagram illustrating a configuration of the movable body 1. The CPU 11, the storage apparatus 12 and the communication apparatus 13 may be interconnected through a data bus 14.

The CPU 11 reads a computer program. For example, the CPU 11 may read a computer program stored in the storage apparatus 12. For example, the CPU 11 may read a computer program stored in a computer-readable recording medium, by using a not-illustrated recording medium reading apparatus. The CPU 11 may obtain (namely, download or read) a computer program from a not-illustrated apparatus placed outside the movable body 1 through the communication apparatus 13. The CPU 11 executes the read computer program. As a result, a logical functional block for autonomously moving under the control of the control server 3 is implemented in the CPU 11. Namely, the CPU 11 is configured to serve as a controller for implementing the logical block for autonomously moving under the control of the control server 3.

The storage apparatus 12 is configured to store desired data. For example, the storage apparatus 12 may temporarily store the computer program that is executed by the CPU 11. The storage apparatus 12 may temporarily store data temporarily used by the CPU 11 when the CPU 11 executes the computer program. The storage apparatus 12 may store data stored for a long term by the movable body 1. The storage apparatus 12 may include at least one of a RAM (Random Access Memory), a ROM (Read Only Memory), a hard disk apparatus, a magneto-optical disc, a SSD (Solid State Drive) and a disk array apparatus.

The communication apparatus 13 is configured to communicate with the control server 3 through a wireless communication network NW that is built by the plurality of wireless access points 2. Especially in the present example embodiment, the communication apparatus 13 is configured to receive a control information from the control server 3 (specifically, a command signal that is transmitted to the movable body 1 from the control server 3 to control the movable body 1) through the wireless communication network NW. The CPU 11 may control at least one of a driving unit (for example, a motor), a braking unit and a steering unit of the movable body 1 so that the movable body 1 autonomously moves based on the received control information.

Again in FIG. 1 and FIG. 2, each wireless access point 2 builds the wireless communication network NW in the transport area TA. Each wireless access point 2 is configured to wirelessly communicate with the movable body 1 located in a communication cell of each wireless access point 2. The movable body 1 is configured to communicate with the control server 3 through the wireless communication network NW built by the plurality of wireless access points 2. The movable body 1 is configured to communicate with the control server 3 through at least one of the plurality of wireless access points 2. Thus, each wireless access point 2 is connected to the control server 3 to communicate with it through a communication network N including at least one of a wired communication network and a wireless communication network. Since the plurality of movable bodies 1 move in the transport area TA, it is preferable that the plurality of wireless access points 2 be located discretely in the transport area TA.

The control server 3 performs a movable body control operation for controlling each movable body 1 so that each movable body 1 autonomously move in the transport area TA. The control server 3 includes a CPU 31, a storage apparatus 32 and a communication apparatus 33, as illustrated in FIG. 4 that is a block diagram illustrating a configuration of the control server 3. The CPU 31, the storage apparatus 32 and the communication apparatus 33 may be interconnected through a data bus 34.

The CPU 31 reads a computer program. For example, the CPU 31 may read a computer program stored in the storage apparatus 32. For example, the CPU 31 may read a computer program stored in a computer-readable recording medium, by using a not-illustrated recording medium reading apparatus. The CPU 31 may obtain (namely, download or read) a computer program from a not-illustrated apparatus placed outside the control server 3 through the communication apparatus 33. The CPU 31 executes the read computer program. As a result, a logical functional block for performing the movable body control operation that should be performed by the control server 3 is implemented in the CPU 31. Namely, the CPU 31 is configured to serve as a controller for implementing the logical block for performing the movable body control operation.

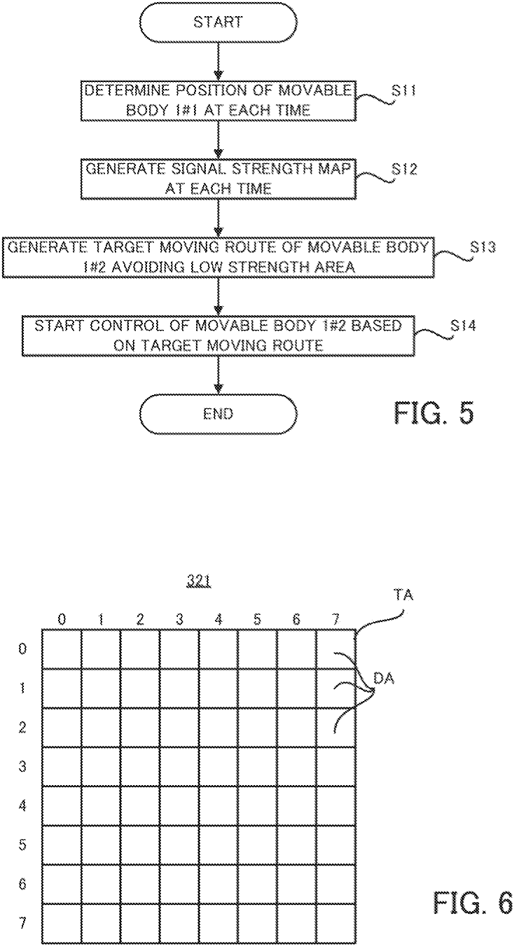

In order to perform the movable body control operation, a route generation unit 311 that is one specific example of a “generation unit” and a movable body control unit 312 that is one specific example of a “control unit” are implemented in the CPU 31. Note that a detail of an operation of each of the route generation unit 311 and the movable body control unit 312 will be described later in detail with reference to FIG. 5 and so on, however, an overview thereof will be briefly described here. The route generation unit 311 is configured to generate the target moving route TGT for each movable body 1 in the transport area TA. Specifically, the route generation unit 311 is configured to generate, as the target moving route TGT for one movable body 1, a route that allows the one movable body 1 to move while avoiding a below described low strength area DA_low that is generated in the transport area TA due to other movable body 1 of the plurality of movable bodies 1 other than the one movable body 1. The movable body control unit 312 is configured to control each movable body 1 through the wireless communication network NW so that each movable body 1 moves along the generated target moving route TGT.

The storage apparatus 32 is configured to store desired data. For example, the storage apparatus 32 may temporarily store the computer program that is executed by the CPU 31. The storage apparatus 32 may temporarily store data temporarily used by the CPU 31 when the CPU 31 executes the computer program. The storage apparatus 32 may store data stored for a long term by the control server 3. Especially in the present example embodiment, the storage apparatus 32 store data used by the CPU 31 for performing the movable body control operation. Specifically, the storage apparatus 32 stores a grid map 321, a signal strength DB 322 and a moving route DB 323. The grid map 321 is map data that is used by the CPU 31 for generating the target moving route TGT by a unit of a plurality of grid areas that are obtained by dividing the transport area TA. The signal strength DB 322 is a database storing an signal strength information related to a level of a signal strength in the transport area TA when each movable body 1 exists in each of a plurality of different locations in the transport area TA. The signal strength DB 322 is mainly used to determine the above described low strength area DA_low. The moving route DB 323 stores a route information related to the target moving route TGT generated by the route generation unit 311. The storage apparatus 32 may include at least one of a RAM, a ROM, a hard disk apparatus, a magneto-optical disc, a SSD and a disk array apparatus.

The communication apparatus 33 is configured to communicate with each of the plurality of movable bodies 1 through the wireless communication network NW. Especially in the present example embodiment, the communication apparatus 33 is configured to transmit the control information for controlling the movable body 1 (specifically, the command signal that is transmitted to the movable body 1 from the control server 3 to control the movable body 1). Each movable body 1 autonomously moves based on the control information transmitted from the control server 3.

### Operation of Control Server 3

Next, with reference to FIG. 5, the movable body control operation performed by the control server 3 will be described. FIG. 5 is a flowchart that illustrates a flow of the movable body control operation performed by the control server 3. Note that the control server 3 performs the first movable body control operation individually (in other words, in parallel) for each of the plurality of movable bodies 1.

As described above, the control server 3 generates, as the target moving route TGT for one movable body 1, the route that allows the one movable body 1 to move while avoiding the low strength area DA_low that is generated in the transport area TA due to other movable body 1 of the plurality of movable bodies 1 other than the one movable body 1. In the below described description, a flow of the movable body control operation that is performed when the movable body control system SYS includes two movable bodies 1 (specifically, a movable body 1#1 and a movable body 1#2) will be described, for the purpose of simple description. Namely, in the below described description, the movable body control operation for generating, as the target moving route TGT for the movable body 1#2, the route that allows the movable body 1#2 to move while avoiding the low strength area DA_low that is generated in the transport area TA due to the movable body 1#1. In this case, the movable body 1#1 is one specific example of a “first movable body” and the movable body 1#2 is one specific example of a “second movable body”. However, even when the movable body control system SYS includes three or more movable bodies, a detail of the movable control operation is not changed except that there are a plurality of movable bodies 1#1.

As illustrated in FIG. 5, the route generation unit 311 determines a position of the movable body 1#1 at each time in a movement period during which the movable body 1#2 moves from a movement start position to a movement end position (namely, a location at which the movable body 1#1 is located at each time) (a step S11). In the below described description, an example in which the movable body 1#2 starts to move from the movement start position (for example, a current position of the movable body 1#2) at a time t₀ and reaches the movement end position (for example, a destination) at time t₈ will be described for the purpose of simple description. In this case, the route generation unit 311 determines the position of the movable body 1#1 at a time tᵢ (note that i is an integer from 0 to 8). The movement start position and the movement end position are determined based on a task that should be performed by the movable body 1#1 in the transport area TA.

In the present example embodiment, the route generation unit 311 determines the position of the movable body 1#1 on the grid map 321. However, the route generation unit 311 may determine the position of the movable body 1#1 by using any method without using the grid map 321. One example of the grid map 321 is illustrated in FIG. 6. As illustrated in FIG. 6, the grid map 321 is a map that indicates a layout of the transport area TA and a map that is segmentized into a plurality of grid areas DA. In an example illustrated in FIG. 6, the grid map 321 is segmentized into the plurality of grid areas DA that distribute in a matrix manner. However, the grid map 321 may be segmentized into the plurality of grid areas DA that distribute in other aspect. The grid map 321 may be segmentized into a plurality of segmentized areas having any shape that distribute in any aspect. A size of the grid area DA may be set based on a size of the movable body 1. For example, the size of the grid area DA may be set to be a size that allows each grid area DA to include one movable body 1.

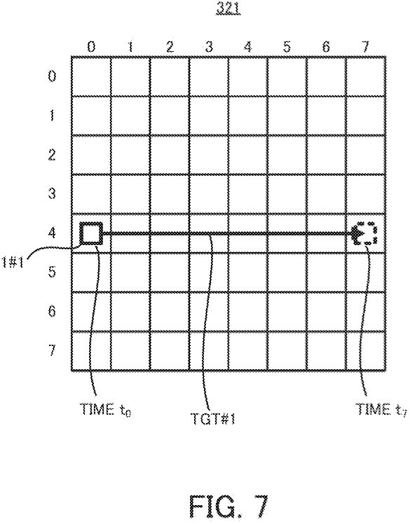

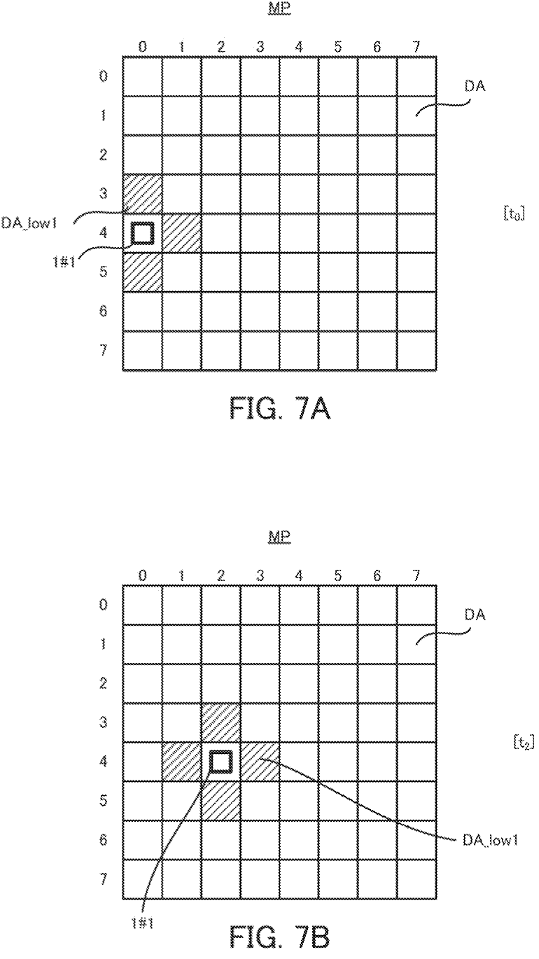

The route generation unit 311 may determine, as the position of the movable body 1#1, a position of the grid area DA in which the movable body 1 exists at each time during the movement period. In order to determine the position of the movable body 1#1, the route generation unit 311 may obtains a route information related to the target moving route TGT for the movable body 1#1 (hereinafter, the target moving route TGT for the movable body 1#1 is referred to as a “target moving route TGT#1”) that is stored in the moving route DB 323. Note that the route information is one specific example of a “location information”. Then, the route generation unit 311 determines the position of the movable body 1#1 at each time in the movement period based on the obtained route information related to the target moving route TGT#1. For example, FIG. 7 illustrates one example of the target moving route TGT#1 for the movable body 1#1 on the grid map 321. As illustrated in FIG. 7, the target moving route TGT#1 indicates that the movable body 1#1 moves from the time t₀ to the time t₇ so that the movable body 1#1 reaches the grid area DA at a coordinate (7, 4) from the grid area DA at a coordinate (0, 4) while passing through the grid area DA at a coordinate (1, 4), the grid area DA at a coordinate (2, 4), the grid area DA at a coordinate (3, 4), the grid area DA at a coordinate (4, 4), the grid area DA at a coordinate (5, 4) and the grid area DA at a coordinate (6, 4) in this order and the movable body 1#1 stops in the grid area at the coordinate (7, 4). Incidentally, in the present example embodiment, the coordinate of the grid area DA is represented by using coordinate in which a coordinate in a horizontal direction in a drawing and a coordinate in a vertical direction in a drawing are listed as numbers in this order, for the purpose of description. In this case, the route generation unit 311 determines that the position of the movable body 1#1 at the time t₀ is the coordinate (0, 4), the position of the movable body 1#1 at the time t₁ is the coordinate (1, 4), the position of the movable body 1#1 at the time t₂ is the coordinate (2, 4), the position of the movable body 1#1 at the time t₃ is the coordinate (3, 4), the position of the movable body 1#1 at the time t₄ is the coordinate (4, 4), the position of the movable body 1#1 at the time t₅ is the coordinate (5, 4), the position of the movable body 1#1 at the time t₆ is the coordinate (6, 4) and the position of the movable body 1#1 from the time t₇ to the time t₈ is the coordinate (7, 4).

Incidentally, when the movable body control system SYS includes three or more movable bodies 1 (namely, includes two or more movable bodies 1#1), the route generation unit 311 may determine the position of each of the two or more movable bodies 1#1 at each time in the movement period at the step S11.

Then, the route generation unit 311 generates, based on the position of the movable body 1#1 determined at the step S11 and the signal strength information stored in the signal strength DB 322, a signal strength map MP that indicates a signal strength in the transport area TA at each time tᵢ in the movement period on the grid map 321 (a step S12).

Specifically, the signal strength DB 322 stores a plurality of signal strength information that correspond to the plurality of movable bodies 1, respectively. The signal strength information corresponding to one movable body 1 of the plurality of movable bodies 1 obtains a signal strength information that indicates a magnitude of the signal strength in the transport area TA when the one movable body 1 exists in each of the plurality of grid areas DA that are obtained by segmentizing the transport area TA. In the example illustrated in FIG. 6, the transport area TA is segmentized into 64 grid areas DA the position of each of which is indicated by the coordinate (x (note that x is an integer from 0 to 7), y (note that y is an integer from 0 to 7)). In this case, the signal strength information corresponding to one movable body 1 may include a signal strength information that indicates the magnitude of the signal strength in the transport area TA when the one movable body 1 exists in the grid area DA at the coordinate (0, 0), a signal strength information that indicates the magnitude of the signal strength in the transport area TA when the one movable body 1 exists in the grid area DA at the coordinate (0, 1), a signal strength information that indicates the magnitude of the signal strength in the transport area TA when the one movable body 1 exists in the grid area DA at the coordinate (0, 2), ..., a signal strength information that indicates the magnitude of the signal strength in the transport area TA when the one movable body 1 exists in the grid area DA at the coordinate (6, 7), and a signal strength information that indicates the magnitude of the signal strength in the transport area TA when the one movable body 1 exists in the grid area DA at the coordinate (7, 7).

At the step S12, the route generation unit 311 obtains the signal strength information corresponding to the movable body 1#1 from the signal strength DB 322. Note that the signal strength information corresponding to the movable body 1#1 is one specific example of a “first communication quality information”. Then, the route generation unit 311 generates, based on the obtained signal strength information, the signal strength map MP that indicates the magnitude of the signal strength in the transport area TA on the grid map 321 when the movable body 1#1 exists at the position determined at the step S11. Specifically, the route generation unit 311 generates the signal strength map MP(t₀) that indicates the magnitude of the signal strength in the transport area TA on the grid map 321 when the movable body 1#1 exists in the grid area DA at the coordinate (0, 4) at the time t₀, the signal strength map MP(t₁) that indicates the magnitude of the signal strength in the transport area TA on the grid map 321 when the movable body 1#1 exists in the grid area DA at the coordinate (1, 4) at the time t₁, ..., and the signal strength map MP(t₈) that indicates the magnitude of the signal strength in the transport area TA on the grid map 321 when the movable body 1#1 exists in the grid area DA at the coordinate (7, 4) at the time t₈.

One example of the signal strength map MP is illustrated in FIG. 8A and FIG. 8B. FIG. 8A illustrates the signal strength map MP(t₀) that indicates the magnitude of the signal strength in the transport area TA on the grid map 321 when the movable body 1#1 exists in the grid area DA at the coordinate (0, 4) at the time t₀. FIG. 8B illustrates the signal strength map MP(t₂) that indicates the magnitude of the signal strength in the transport area TA on the grid map 321 when the movable body 1#1 exists in the grid area DA at the coordinate (2, 4) at the time t₂. As illustrated in FIG. 8A and FIG. 8B, the signal strength map MP indicates the position in the transport area TA of the grid area DA in which the signal strength is lower than a desired strength. In the below described description, the grid area DA in which the signal strength is lower than the desired strength is referred to as the “low strength area DA_low”. Especially, the signal strength map MP illustrated in FIG. 8A and FIG. 8B indicates the position in the transport area TA of the grid area DA in which the signal strength is lower than the desired strength due to the movable body 1#1, because it is the signal strength map MP corresponding to the movable body 1#1. In the below described description, the grid area DA in which the signal strength is lower than the desired strength due to the movable body 1#1 is referred to as a “low strength area DA_low1”. This low strength area DA_low1 is generated in the transport area TA due to the existence of the movable body 1#1. Thus, as illustrated in FIG. 8A and FIG. 8B, the low strength area DA_low1 typically moves in the transport area TA along with the movement of the movable body 1#1. Note that the desired strength corresponds to a threshold value that allows the signal strength in a situation where the communication between the movable body 1 and the control server 3 is stable to be distinguished from the signal strength in a situation where the communication between the movable body 1 and the control server 3 is not stable. Moreover, the low strength area DA_low1 is one specific example of a “first low quality location”.

A communication quality in the wireless communication network NW that is built by the plurality of wireless access points 2 is better as the signal strength is higher. Namely, the communication quality in the grid area DA is better as the signal strength in this grid area DA is higher. Thus, it can be said that the signal strength information is one specific example of a communication quality information related to the communication quality in the wireless communication network NW in the transport area TA.

Incidentally, when the movable body control system SYS includes three or more movable bodies 1 (namely, includes two or more movable bodies 1#1), the route generation unit 311 may generate two or more signal strength maps MP that correspond to the two or more movable bodies 1#1, respectively, and then generate the signal strength map MP at each time tᵢ by combining the two or more signal strength maps MP at the step S12.

Then, the route generation unit 311 generates, based on the signal strength map MP generated at the step S12, the target moving route TGT for the movable body 1#2 (hereinafter, the target moving route TGT for the movable body 1#2 is referred to as a “target moving route TGT#2”) (a step S13).

Specifically, the route generation unit 311 generates the target moving route TGT#2 that satisfies such a first route condition that the movable body 1#2 is movable while avoiding the low strength area DA_low1. Namely, the route generation unit 311 generates the target moving route TGT#2 that allows the movable body 1#2 to move while avoiding the low strength area DA_low1. Here, a state where “the movable body 1#2 is movable while avoiding the low strength area DA_low1” in the present example embodiment may mean a state where “the movable body 1#2 exists at each time tᵢ in the grid area DA that is different from the low strength area DA_low1 generated at each time tᵢ”. Namely, the state where “the movable body 1#2 is movable while avoiding the low strength area DA_low1” may mean a state where “the movable body 1#2 exists at the time t₀ in the grid area DA that is different from the low strength area DA_low1 generated at each time t₀, the movable body 1#2 exists at the time t₁ in the grid area DA that is different from the low strength area DA_low1 generated at each time t₁, ..., and the movable body 1#2 exists at the time ts in the grid area DA that is different from the low strength area DA_low1 generated at each time ts”. In this case, it can be said that the first route condition is such a condition that the movable body 1#2 exists at each time tᵢ in the grid area DA that is different from the low strength area DA_low1 generated at each time tᵢ. In other words, it can be said that the first route condition is such a condition that the movable body 1#2 does not exist at each time tᵢ in the low strength area DA_low1 generated at each time tᵢ.

In order to generate the target moving route TGT#2 satisfying the first route condition, the route generation unit 311 determines, based on the signal strength map MP generated at the step S12, the position of the low strength area DA_low1 generated at each time tᵢ. Then, the route generation unit 311 generates the target moving route TGT#2 that allows the movable body 1#2 to move while avoiding the determined low strength area DA_low1. When the target moving route TGT#2 satisfying the first route condition is generated, there is a relatively low possibility that the communication between the movable body 1#2 and the control server 3 is unstable due to the low strength area DA_low1.

Incidentally, when the movable body control system SYS includes three or more movable bodies 1 (namely, includes two or more movable bodies 1#1), the first route condition may be such a condition that the movable body 1#2 is movable while avoiding a plurality of low strength areas DA_low1 that are generated due to the plurality of movable bodies 1#1, respectively.

On the other hand, the low strength area DA_low may be generated due to not only the movable body 1#1 but also the movable body 1#2. In the below described description, the low strength area DA_low generated due to the movable body 1#2 is referred to as a “low strength area DA_low2” to distinguish it from the low strength area DA_low1. There is a possibility that this low strength area DA_low2 moves along with the movement of the movable body 1#2. Thus, when the movable body 1#1 enters the low strength area DA_low2 moving along with the movement of the movable body 1#2, there is a possibility that the communication quality between the movable body 1#1 and the control server 3 is unstable due to the low strength area DA_low2. Thus, there is a possibility that the movable body 1#1 is not capable of properly moving in the transport area TA under the control of the control server 3. Thus, the route generation unit 311 may generate the target moving route TGT#2 that satisfies, in addition to the above described first route condition, such a second route condition that the movable body 1#1 does not exist in the low strength area DA_low2 generated due to the movable body 1#2 moving along the target moving route TGT#2. Here, a state where “the movable body 1#1 does not exist in the low strength area DA_low2” may mean a state where “the movable body 1#1 does not exist at each time tᵢ in the low strength area DA_low2 generated at each time tᵢ”. Namely, the state where “the movable body 1#1 does not exist in the low strength area DA_low2” may mean a state where “the movable body 1#1 does not exist at the time t₀ in the low strength area DA_low2 generated at the time t₀, the movable body 1#1 does not exist at the time t₁ in the low strength area DA_low2 generated at the time t₁, ... and the movable body 1#1 does not exist at the time t₈ in the low strength area DA_low2 generated at the time t₈”. In other words, the state where “the movable body 1#1 does not exist in the low strength area DA_low2” may mean a state where “the movable body 1#1 exists at the time t₀ in the grid area DA that is different from the low strength area DA_low2 generated at the time t₀, the movable body 1#1 exists at the time t₁ in the grid area DA that is different from the low strength area DA_low2 generated at the time t₁, ... and the movable body 1#1 exists at the time t₈ in the grid area DA that is different from the low strength area DA_low2 generated at the time ts”. In this case, it can be said that the second route condition is such a condition that the movable body 1#1 exists at each time tᵢ in the grid area DA that is different from the low strength area DA_low2 generated at each time tᵢ. In other words, it can be said that the second route condition is such a condition that the movable body 1#1 does not exist at each time tᵢ in the low strength area DA_low2 generated at each time tᵢ.

In order to generate the target moving route TGT#2 satisfying the second route condition, the route generation unit 311 obtains the signal strength information corresponding to the movable body 1#2 from the signal strength DB 322, and determines, based on the obtained signal strength information, the position of the low strength area DA_low2 generated at each time tᵢ. Then, the route generation unit 311 generates the target moving route TGT#2 that allows the movable body 1#1 not to exist the determined low strength area DA_low2. When the target moving route TGT#2 satisfying the second route condition is generated, there is a relatively low possibility that the communication between the movable body 1#1 and the control server 3 is unstable due to the low strength area DA_low2.

Incidentally, when the movable body control system SYS includes three or more movable bodies 1 (namely, includes two or more movable bodies 1#1), the first route condition may be such a condition that each of the plurality of movable bodies 1#1 does not exist in the low strength areas DA_low2.

The route generation unit 311 may generate the target moving route TGT#2 by using an existing route generation method. For example, the route generation unit 311 may generate the target moving route TGT#2 by using an existing route generation method based on an A* (A star) algorithm. In this case, in order to generate the target moving route TGT#2 satisfying the first route condition that allows the movable body 1#2 to move while avoiding the low strength area DA_low1, the route generation unit 311 may set a cost for the low strength area DA_low1 to be higher than a cost for the grid area DA other than the low strength area DA_low1. Then, the route generation unit 311 may generate the target moving route TGT#2 so that a total sum of the costs for the grid areas DA through which the target moving route TGT#2 passes is smaller (typically, is minimum). Moreover, in order to generate the target moving route TGT#2 satisfying the second route condition that allows the movable body 1#1 not to exist in the low strength area DA_low2, the route generation unit 311 may set a cost for the low strength area DA_low2 to be higher than a cost for the grid area DA other than the low strength area DA_low2, and generate the target moving route TGT#2 so that a total sum of the costs for the grid areas DA through which the target moving route TGT#1 for the movable body 1#1 passes is smaller (typically, is minimum).

After the target moving route TGT#2 is generated, the movable body control unit 312 controls the movable body 1#2 through the wireless communication network NW so that the movable body 1#2 moves along the target moving route TGT#2 generated at the step S13 (a step S14). As a result, the movable body 1#2 starts to move. Note that the target moving route TGT#2 generated at the step S13 may be stored in the moving route DB 323 stored in the storage apparatus 32.

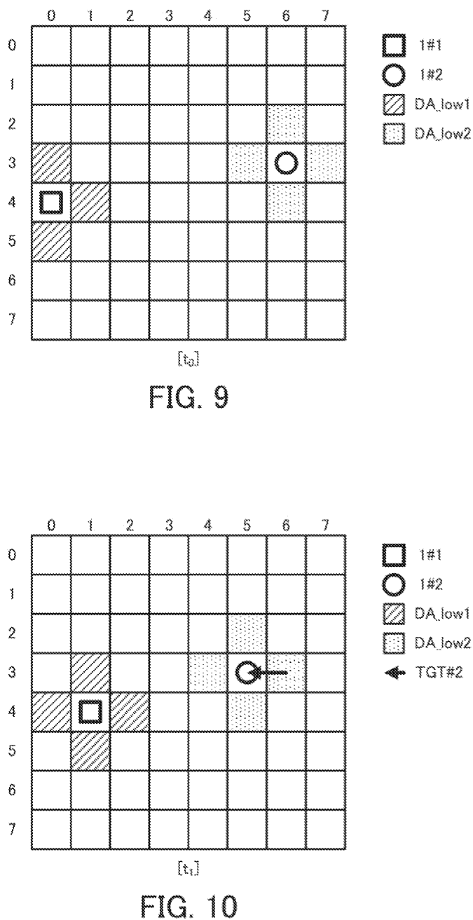

Nex, with reference to FIG. 9 to FIG. 14, a specific example of an operation for generating the target moving route TGT#2 satisfying the first and second route conditions will be described. In the below described description, an operation for generating the target moving route TGT#2 for the movable body 1#2 that starts to move from the movement start position at the coordinate (6, 3) at the time t₀ and reaches the movement end position at the coordinate (0, 3) until the time t₈ in a situation where the movable body 1#1 moves from the grid area DA at the coordinate (0, 4) to the grid area DA at the coordinate (7, 4) from the time t₀ to the time t₇. Each of FIG. 9 and FIG. 14 is a planar view that illustrates the moving movable bodies 1#1 and 1#2 and the low strength areas DA_low1 and DA_low2 that move along with the moving movable bodies 1#1 and 1#2 on the grid map 321.

As illustrated in FIG. 9, the route generation unit 311 determines the coordinate (0, 4) as the position of the movable body 1#1 at the time t₀. Furthermore, the route generation unit 311 determines the coordinate (6, 3) as the position of the movable body 1#2 at the time t₀. Moreover, the route generation unit 311 determines the grid areas DA at the coordinate (0, 3), the coordinate (0, 5) and the coordinate (1, 4) adjacent to the movable body 1#1 as the low strength area DA_low1 at the time t₀. The route generation unit 311 determines the grid areas DA at the coordinate (7, 3), the coordinate (6, 2), the coordinate (6, 4) and the coordinate (5, 3) adjacent to the movable body 1#2 as the low strength area DA_low2 at the time t₀.

Then, as illustrated in FIG. 10, the route generation unit 311 determines the coordinate (1, 4) as the position of the movable body 1#1 at the time t₁. Furthermore, the route generation unit 311 determines the grid areas DA at the coordinate (0, 4), the coordinate (1, 3), the coordinate (1, 5) and the coordinate (2, 4) as the low strength area DA_low1 at the time t₁. On the other hand, the route generation unit 311 determines, as the position of the movable body 1#2 at the time t₁, the coordinate (5, 3) that should be passed through to move from the coordinate (6, 3) to the coordinate (0, 3) along the shortest way, in order to minimize the cost of the target moving route TGT#2. The target moving route TGT#2 including a route from the coordinate (6, 3) to the coordinate (5, 3) satisfies the first route condition, because the grid area DA at the coordinate (5, 3) is not the low strength area DA_low1. Furthermore, after determining the coordinate (5, 3) as the position of the movable body 1#2 at the time t₁, the route generation unit 311 determines the grid areas DA at the coordinate (6, 3), the coordinate (5, 2), the coordinate (5, 4) and the coordinate (4, 3) as the low strength area DA_low2 at the time t₁. The target moving route TGT#2 including the route from the coordinate (6, 3) to the coordinate (5, 3) satisfies the second route condition, because the grid area DA at the coordinate (1, 4) in which the movable body 1#1 is located at the time t₁ is not the low strength area DA_low2. Therefore, the route from the coordinate (6, 3) to the coordinate (5, 3) is fixed as a part of the target moving route TGT#2.

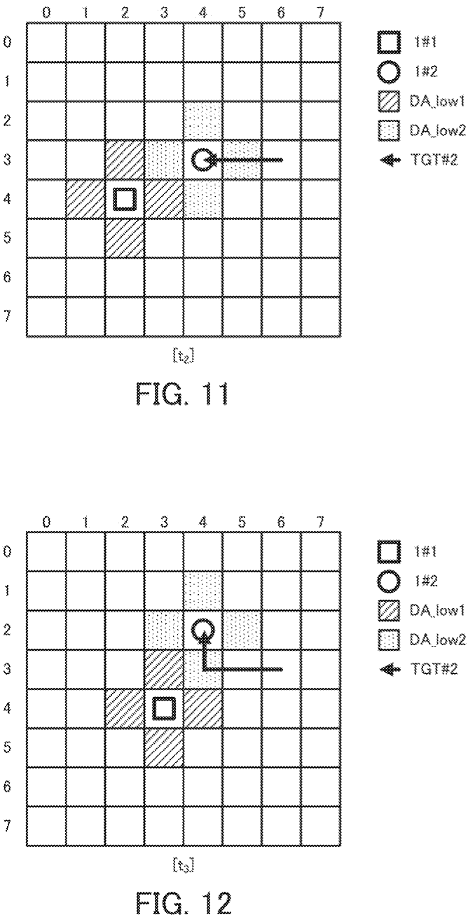

Then, as illustrated in FIG. 11, the route generation unit 311 determines the coordinate (2, 4) as the position of the movable body 1#1 at the time t₂. Furthermore, the route generation unit 311 determines the grid areas DA at the coordinate (1, 4), the coordinate (2, 3), the coordinate (2, 5) and the coordinate (3, 4) as the low strength area DA_low1 at the time t₂. On the other hand, the route generation unit 311 determines, as the position of the movable body 1#2 at the time t₂, the coordinate (4, 3) that should be passed through to move from the coordinate (5, 3) to the coordinate (0, 3) along the shortest way, in order to minimize the cost of the target moving route TGT#2. The target moving route TGT#2 including a route from the coordinate (5, 3) to the coordinate (4, 3) satisfies the first route condition, because the grid area DA at the coordinate (4, 3) is not the low strength area DA_low1. Furthermore, after determining the coordinate (4, 3) as the position of the movable body 1#2 at the time t₂, the route generation unit 311 determines the grid areas DA at the coordinate (5, 3), the coordinate (4, 2), the coordinate (4, 4) and the coordinate (3, 3) as the low strength area DA_low2 at the time t₂. The target moving route TGT#2 including the route from the coordinate (5, 3) to the coordinate (4, 3) satisfies the second route condition, because the grid area DA at the coordinate (2, 4) in which the movable body 1#1 is located at the time t₂ is not the low strength area DA_low2. Therefore, the route from the coordinate (5, 3) to the coordinate (4, 3) is fixed as a part of the target moving route TGT#2.

Then, as illustrated in FIG. 12, the route generation unit 311 determines the coordinate (3, 4) as the position of the movable body 1#1 at the time t₃. Furthermore, the route generation unit 311 determines the grid areas DA at the coordinate (2, 4), the coordinate (3, 3), the coordinate (3, 5) and the coordinate (4, 4) as the low strength area DA_low1 at the time t₃. On the other hand, the route generation unit 311 determines, as the position of the movable body 1#2 at the time t₃, the coordinate (3, 3) that should be passed through to move from the coordinate (4, 3) to the coordinate (0, 3) along the shortest way, in order to minimize the cost of the target moving route TGT#2. However, the target moving route TGT#2 including a route from the coordinate (4, 3) to the coordinate (3, 3) does not satisfy the first route condition, because the grid area DA at the coordinate (3, 3) is the low strength area DA_low1. Thus, the route generation unit 311 determines, as the position of the movable body 1#2 at the time t₃, the coordinate (the coordinate (4, 2) in an example illustrated in FIG. 12) that is adjacent to the coordinate (4, 3) and that is different from the coordinate (3, 3). The target moving route TGT#2 including a route from the coordinate (4, 3) to the coordinate (4, 2) satisfies the first route condition, because the grid area DA at the coordinate (4, 2) is not the low strength area DA_low1. Furthermore, after determining the coordinate (4, 2) as the position of the movable body 1#2 at the time t₃, the route generation unit 311 determines the grid areas DA at the coordinate (5, 2), the coordinate (4, 1), the coordinate (4, 3) and the coordinate (3, 2) as the low strength area DA_low2 at the time t₃. The target moving route TGT#2 including the route from the coordinate (4, 3) to the coordinate (4, 2) satisfies the second route condition, because the grid area DA at the coordinate (3, 4) in which the movable body 1#1 is located at the time t₃ is not the low strength area DA_low2. Therefore, the route from the coordinate (4, 3) to the coordinate (4, 2) is fixed as a part of the target moving route TGT#2.

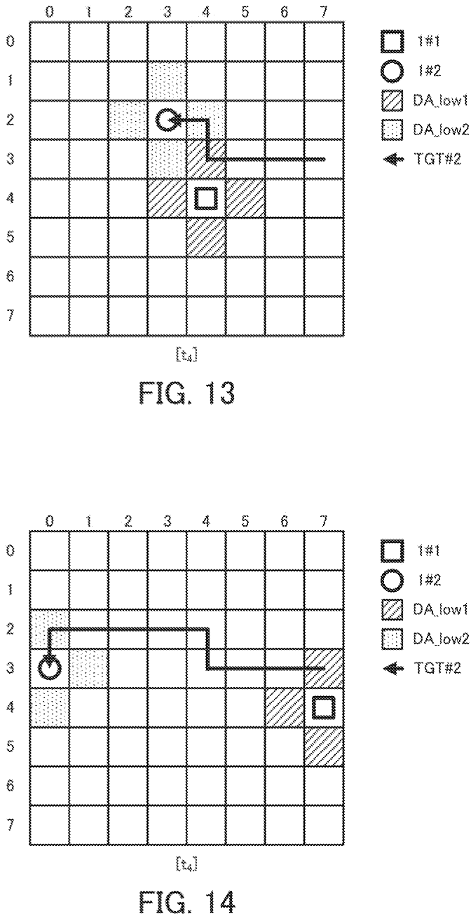

Then, as illustrated in FIG. 13, the route generation unit 311 determines the coordinate (4, 4) as the position of the movable body 1#1 at the time t₄. Furthermore, the route generation unit 311 determines the grid areas DA at the coordinate (3, 4), the coordinate (4, 3), the coordinate (4, 5) and the coordinate (5, 4) as the low strength area DA_low1 at the time t₄. On the other hand, the route generation unit 311 determines, as the position of the movable body 1#2 at the time t₄, the coordinate (3, 2) that should be passed through to move from the coordinate (4, 2) to the coordinate (0, 3) along the shortest way, in order to minimize the cost of the target moving route TGT#2. The target moving route TGT#2 including a route from the coordinate (4, 2) to the coordinate (3, 2) satisfies the first route condition, because the grid area DA at the coordinate (3, 2) is not the low strength area DA_low1. Furthermore, after determining the coordinate (3, 2) as the position of the movable body 1#2 at the time t₄, the route generation unit 311 determines the grid areas DA at the coordinate (4, 2), the coordinate (3, 1), the coordinate (3, 3) and the coordinate (2, 2) as the low strength area DA_low2 at the time t₄. The target moving route TGT#2 including the route from the coordinate (4, 2) to the coordinate (3, 2) satisfies the second route condition, because the grid area DA at the coordinate (4, 4) in which the movable body 1#1 is located at the time t₄ is not the low strength area DA_low2. Therefore, the route from the coordinate (4, 2) to the coordinate (3, 2) is fixed as a part of the target moving route TGT#2.

Then, the same operation is repeated, and thus, a route from the coordinate (6, 3) to the coordinate (0, 3) through the coordinate (5, 3), the coordinate (4, 3), the coordinate (4, 2), the coordinate (3, 2), the coordinate (2, 2), the coordinate (1, 2) and the coordinate (0, 2) in this order is generated as the target moving route TGT#2.

In this manner, it can be said that the route generation unit 311 repeats, while changing the time tᵢ, an operation for determining the position of the movable body 1#1 at the time tᵢ, determining the position of the low strength area DA_low1 at the time tᵢ based on the position of the movable body 1#1 at the time tᵢ, and generating the route that allows the movable body 1#2 to move so that the movable body 1#2 exists at the time tᵢ in the grid area DA other than the low strength area DA_low1 at the time tᵢ in order to generate the target moving route TGT#2 satisfying the first route condition. Moreover, it can be said that the route generation unit 311 repeats, while changing the time tᵢ, an operation for determining the position of the movable body 1#2 at the time tᵢ, determining the position of the low strength area DA_low2 at the time tᵢ based on the position of the movable body 1#2 at the time tᵢ, and generating the route that allows the movable body 1#2 to move so that the movable body 1#1 exists at the time tᵢ in the grid area DA other than the low strength area DA_low2 at the time tᵢ, in order to generate the target moving route TGT#2 satisfying the second route condition.

### Technical Effect of Movable Body Control System SYS

As described above, the movable body control system SYS (especially, the control server 3) in the present example embodiment is capable of generating, based on the signal strength information stored in the signal strength DB 322, the target moving route TGT#2 satisfying the first condition that allows the movable body 1#2 to move while avoiding the low strength area DA_low1. Here, as described above, the signal strength information indicates the magnitude of the signal strength in the transport area TA when the movable body 1#1 exists in each of the plurality of grid areas DA. Thus, the movable body control system SYS is capable of generating the target moving route TGT#2 that allows the movable body 1#2 to move while avoiding the low strength area DA_low1 that moves along with the movement of the movable body 1#1. Therefore, even when the movable body 1#1 other than the movable body 1#2 exists in the transport area TA, there is a low possibility that the communication between the movable body 1#2 and the control server 3 is unstable due to the low strength area DA_low1 generated due to the movable body 1#1. Thus, the movable body 1#2 is capable of properly moving in the transport area TA under the control of the control server 3. Namely, the control server 3 is capable of properly controlling the plurality of movable bodies 1 even when the plurality of movable bodies 1 exist in the transport area TA.

Here, since the signal strength information is stored in the signal strength DB 322 in advance, the control server 3 is capable predicting the position of the low strength area DA_low1 generated in the transport area TA before the movable body 1#2 starts to move. Thus, there is a relatively low possibility that the movable body 1#2 passes through the low strength area DA_low1 after the movable body 1#2 starts to move. As a result, there is a relatively low possibility that it is necessary to generate the target moving route TGT#2 again because of the movable body 1#2 passing through the low strength area DA_low1. Considering this effect, it is preferable that the control server 3 perform the above described movable body control operation illustrated in FIG. 5 before the movable body 1#2 starts to move. Namely, it is preferable that the control server 3 perform the above described movable body control operation illustrated in FIG. 5 before the movable body 1, which is a target for generating the target moving route TGT by the movable body control operation, starts to move. However, the control server 3 may perform the movable body control operation illustrated in FIG. 5 after the movable body 1#2 starts to move. Namely, the control server 3 may perform the movable body control operation illustrated in FIG. 5 after the movable body 1, which is a target for generating the target moving route by the movable body control operation, starts to move.

Furthermore, the movable body control system SYS (especially, the control server 3) is capable of generating the target moving route TGT#2 satisfying the second condition that allows the movable body 1#1 not to exist the low strength area DA_low2. Thus, the movable body control system SYS is capable of generating the target moving route TGT#2 for the movable body 1#2 so that the movable body 1#1 is capable of moving while avoiding the low strength area DA_low2 that moves along with the movement of the movable body 1#2. Therefore, even when the movable body 1#1 other than the movable body 1#2 exists in the transport area TA, there is a low possibility that the communication between the movable body 1#1 and the control server 3 is unstable due to the low strength area DA_low1 generated due to the movable body 1#2. Thus, not only the movable body 1#2 but also the movable body 1#1 are capable of properly moving in the transport area TA under the control of the control server 3. Namely, the control server 3 is capable of properly controlling the plurality of movable bodies 1 even when the plurality of movable bodies 1 exist in the transport area TA.

As described above, when the target moving route TGT#2 satisfying at least one of the first and second route conditions is generated, there is a lower possibility that the plurality of movable bodies 1 interfere with the communication between each other, compared to a case where the target moving route TGT#2 that does not satisfy both of the first and second route conditions is generated. Thus, the plurality of movable bodies 1 are capable of properly moving in the transport area TA even when the plurality of movable bodies 1 exist in the transport area TA. Namely, each movable body 1 is capable of properly moving in the transport area TA without being affected from the interference to the communication from other movable body 1.

### Modified Example

In the above described description, the control server 3 generates the target moving route TGT by using the signal strength information stored in the signal strength DB 322. However, the control server 3 may generate the target moving route TGT by using any communication quality information related to a communication quality of the wireless communication network NW built by the plurality of wireless access points 2 in the transport area TA. An information related to a S/N ratio of the wireless signal is one example of any communication quality information. In this case, the control server 3 may generate the target moving route TGT#2 that allows the movable body 1#2 to move while avoiding a low quality area in which the communication quality does not reach a desired quality due to the movable body 1#1. The control server 3 may generate the target moving route TGT#2 for the movable body 1#2 so that the movable body 1#1 does not exist in a low quality area in which the communication quality does not reach the desired quality due to the movable body 1#2.

### Supplementary Note

With respect to the example embodiments described above, the following Supplementary Notes will be further disclosed.

### Supplementary Note 1

A movable body control system including:
a first movable body that is movable in a predetermined area in which a wireless communication network is built;
a second movable body that is movable in the predetermined are; and
a control apparatus that is configured to control each of the first and second movable bodies through the wireless communication network,
the control apparatus including:
   a storage unit that is configured to store a first communication quality information that indicates a communication quality in the predetermined area when the first movable body exists in each of a plurality of different locations in the predetermined area;
   a generation unit that is configured to generate, based on the first communication quality information, a target moving route that allows the second movable body to move while avoiding a first low quality location at which the communication quality does not reach a desired quality due to the first movable body; and
   a control unit that is configured to control the second movable body so that the second movable body moves along the target moving route.

### Supplementary Note 2

The movable body control system according to Supplementary Note 1, wherein

the generation unit is configured to generate the target moving route before the second movable body starts to move.

### Supplementary Note 3

The movable body control system according to Supplementary Note 1 or 2, wherein the generation unit is configured to:
determine, based on the first communication quality information, the first low quality location that is generated at one time in a movement period during which the second movable body moves; and
generate the target moving route that allows the second movable body to move so that the second movable body exists at the one time at a location that is different from the determined first low quality location.

### Supplementary Note 4

The movable body control system according to Supplementary Note 3, wherein

the generation unit is configured to generate the target moving route by performing, while changing the one time, an operation for determining, based on the first communication quality information, the first low quality location that is generated at the one time, and generating a route that allows the second movable body to move so that the second movable body exists at the one time at the location that is different from the determined first low quality location.

### Supplementary Note 5

The movable body control system according to Supplementary Note 3 or 4, wherein the generation unit is configured to:
determine, based on a location information related to a location at which the first movable body is expected to exist in the movement period, one location at which the first movable body exists at the one time;
determine, based on the first communication quality information, the communication quality when the first movable body exists at the determined one location; and
determine, based on the determined communication quality, the first low quality location that is generated at the one time.

### Supplementary Note 6

The movable body control system according to any one of Supplementary Notes 1 to 5, wherein
the storage unit is configured to further store a second communication quality information that indicates a communication quality in the predetermined area when the second movable body exists in each of a plurality of different locations in the predetermined area;
the generation unit is configured to generate, based on the second communication quality information, the target moving route so that the first movable body does not exist at a second low quality location at which the communication quality does not reach the desired quality due to the second movable body moving along the target moving route.

### Supplementary Note 7

The movable body control system according to Supplementary Note 6, wherein the generation unit is configured to:
determine, based on the second communication quality information, the second low quality location that is generated at one time in a movement period during which the second movable body moves; and
generate the target moving route so that the first movable body exists at the one time at a location that is different from the determined second low quality location.

### Supplementary Note 8

The movable body control system according to Supplementary Note 7, wherein

the generation unit is configured to generate the target moving route by performing, while changing the one time, an operation for determining, based on the second communication quality information, the second low quality location that is generated at the one time, and generating a route that allows the second movable body to move so that the first movable body exists at the one time at the location that is different from the determined second low quality location.

### Supplementary Note 9

A control apparatus that is configured to control, through a wireless communication network, a first movable body and a second movable body that are movable in a predetermined area in which the wireless communication network is built,
the control apparatus including:
a storage unit that is configured to store a first communication quality information that indicates a communication quality in the predetermined area when the first movable body exists in each of a plurality of different locations in the predetermined area;
a generation unit that is configured to generate, based on the first communication quality information, a target moving route that allows the second movable body to move while avoiding a first low quality location at which the communication quality does not reach a desired quality due to the first movable body; and
a control unit that is configured to control the second movable body so that the second movable body moves along the target moving route.

### Supplementary Note 10

A control method of controlling, through a wireless communication network, a first movable body and a second movable body that are movable in a predetermined area in which the wireless communication network is built,
the control method including:
obtaining a fist communication quality information from a storage unit that is configured to store the first communication quality information that indicates a communication quality in the predetermined area when the first movable body exists in each of a plurality of different locations in the predetermined area;
generating, based on the first communication quality information, a target moving route that allows the second movable body to move while avoiding a first low quality location at which the communication quality does not reach a desired quality due to the first movable body; and
controlling the second movable body so that the second movable body moves along the target moving route.

### Supplementary Note 11

The control method according to Supplementary Note 10 including
measuring the communication quality in the predetermined area when the first movable body exists in each of the plurality of different locations in the predetermined area; and
storing an information related to a measured result of the communication quality as the first communication quality information in the storage unit.

### Supplementary Note 12

A computer program that allows a computer to execute a control method is recorded, wherein
the control method
is a control method of controlling, through a wireless communication network, a first movable body and a second movable body that are movable in a predetermined area in which the wireless communication network is built, and
includes:
   obtaining a fist communication quality information from a storage unit that is configured to store the first communication quality information that indicates a communication quality in the predetermined area when the first movable body exists in each of a plurality of different locations in the predetermined area;
   generating, based on the first communication quality information, a target moving route that allows the second movable body to move while avoiding a first low quality location at which the communication quality does not reach a desired quality due to the first movable body; and
   controlling the second movable body so that the second movable body moves along the target moving route.

This disclosure is not limited to the above described example embodiment. This disclosure is allowed to be changed, if desired, without departing from the essence or spirit of the invention which can be read from the claims and the entire specification, and a movable body control system, a control apparatus, a control method and a computer program, which involve such changes, are also intended to be within the technical scope of this disclosure.

This application is based upon and claims the benefit of priority from Japanese Patent Application No. 2020-041803, filed on Mar. 11, 2020, and incorporates all of its disclosure herein, if legally permitted. Moreover, this application incorporates all of the publications of application and articles, if legally permitted.

### DESCRIPTION OF REFERENCE CODES

SYS movable body control system
1 movable body
2 wireless access point
3 control server
31 CPU
311 route generation unit
312 movable body control unit
32 storage apparatus
321 grid map
322 signal strength DB
323 moving route DB
DA grid area
DA_low1, DA_low2 low strength area
MP signal strength map

What is claimed is:

1. A movable body control system comprising:
a first movable body that is movable in a predetermined area in which a wireless communication network is build;
a second movable body that is movable in the predetermined are; and
a control apparatus that is configured to control each of the first and second movable bodies through the wireless communication network,
the control apparatus comprising:
a storage that is configured to store a first communication quality information that indicates a communication quality in the predetermined area when the first movable body exists in each of a plurality of different locations in the predetermined area;
at least one memory configured to store instructions: and
at least one processor configured to execute the instructions to:
generate, based on the first communication quality information, a target moving route that allows the second movable body to move while avoiding a first low quality location at which the communication quality does not reach a desired quality due to the first movable body; and
control the second movable body so that the second movable body moves along the target moving route.

2. The movable body control system according to claim 1, wherein
the at least one processor is configured to execute the instructions to generate the target moving route before the second movable body starts to move.

3. The movable body control system according to claim 1, wherein
the at least one processor is configured to execute the instructions to:
determine, based on the first communication quality information, the first low quality location that is generated at one time in a movement period during which the second movable body moves; and
generate the target moving route that allows the second movable body to move so that the second movable body exists at the one time at a location that is different from the determined first low quality location.

4. The movable body control system according to claim 3, wherein
the at least one processor is configured to execute the instructions to generate the target moving route by performing, while changing the one time, an operation for determining, based on the first communication quality information, the first low quality location that is generated at the one time, and generating a route that allows the second movable body to move so that the second movable body exists at the one time at the location that is different from the determined first low quality location.

5. The movable body control system according to claim , wherein
the at least one processor is configured to execute the instructions to:
determine, based on a location information related to a location at which the first movable body is expected to exist in the movement period, one location at which the first movable body exists at the one time;
determine, based on the first communication quality information, the communication quality when the first movable body exists at the determined one location; and
determine, based on the determined communication quality, the first low quality location that is generated at the one time.

6. The movable body control system according to claim 1, wherein
the storage is configured to further store a second communication quality information that indicates a communication quality in the predetermined area when the second movable body exists in each of a plurality of different locations in the predetermined area;
the at least one processor is configured to execute the instructions to generate, based on the second communication quality information, the target moving route so that the first movable body does not exist at a second low quality location at which the communication quality does not reach the desired quality due to the second movable body moving along the target moving route.

7. The movable body control system according to claim 6, wherein
the at least one processor is configured to execute the instructions to:
determine, based on the second communication quality information, the second low quality location that is generated at one time in a movement period during which the second movable body moves; and
generate the target moving route so that the first movable body exists at the one time at a location that is different from the determined second low quality location.

8. The movable body control system according to claim 7, wherein
the at least one processor is configured to execute the instructions to generate the target moving route by performing, while changing the one time, an operation for determining, based on the second communication quality information, the second low quality location that is generated at the one time, and generating a route that allows the second movable body to move so that the first movable body exists at the one time at the location that is different from the determined second low quality location.

9. (canceled)

10. A control method of controlling, through a wireless communication network, a first movable body and a second movable body that are movable in a predetermined area in which the wireless communication network is, build,
the control method including:
obtaining a fist communication quality information from a storage unit that is configured to store the first communication quality information that indicates a communication quality in the predetermined area when the first movable body exists in each of a plurality of different locations in the predetermined area;
generating, based on the first communication quality information, a target moving route that allows the second movable body to move while avoiding a first low quality location at which the communication quality does not reach a desired quality due to the first movable body; and
controlling the second movable body so that the second movable body moves along the target moving route.

11. The control method according to claim 10 including
measuring the communication quality in the predetermined area when the first movable body exists in each of the plurality of different locations in the predetermined area; and
storing an information related to a measured result of the communication quality as the first communication quality information in the storage unit.

12. A non-transitory recording medium on which a computer program that allows a computer to execute a control method is recorded, wherein
the control method
is a control method of controlling, through a wireless communication network, a first movable body and a second movable body that are movable in a predetermined area in which the wireless communication network is, build, and
includes:
obtaining a fist communication quality information from a storage unit that is configured to store the first communication quality information that indicates a communication quality in the predetermined area when the first movable body exists in each of a plurality of different locations in the predetermined area;
generating, based on the first communication quality information, a target moving route that allows the second movable body to move while avoiding a first low quality location at which the communication quality does not reach a desired quality due to the first movable body; and
controlling the second movable body so that the second movable body moves along the target moving route.
